(19) United States
(12) Patent Application Publication
(10) Pub. No.: US 2016/0094139 A1
(43) Pub. Date: Mar. 31, 2016

(54) MATRIX CONVERTOR, POWER GENERATION SYSTEM, AND METHOD FOR CONVERTING POWER

(71) Applicant: KABUSHIKI KAISHA YASKAWA DENKI, Kitakyushu-shi (JP)

(72) Inventors: Akira YAMAZAKI, Kitakyushu-shi (JP); Joji EBISU, Kitakyushu-shi (JP)

(73) Assignee: KABUSHIKI KAISHA YASKAWA DENKI, Kitakyushu-shi (JP)

(21) Appl. No.: 14/863,451

(22) Filed: Sep. 24, 2015

(30) Foreign Application Priority Data
Sep. 25, 2014 (JP) 2014-195851

(51) Int. Cl. H02M 5/293

(52) U.S. Cl. CPC H02M 5/293; H02M 2005/2932

(57) ABSTRACT

A matrix convertor includes a power convertor, a commutation controller, an error compensator, and a compensation amount adjustor. The power convertor is disposed between input phases and output phases. The power convertor includes a plurality of bidirectional switches each including a plurality of switching elements. The commutation controller is configured to perform commutation control with respect to the plurality of switching elements of each of the plurality of bidirectional switches using a commutation pattern including a plurality of steps so as to switch connection between the input phases and the output phases through the power convertor. The error compensator is configured to calculate a compensation amount to decrease an error in an output voltage caused by the commutation control. The compensation amount adjustor is configured to decrease the compensation amount based on at least one voltage among voltages of the output phases.

### CROSS-REFERENCE TO RELATED APPLICATIONS

The present application claims priority under 35 U.S.C. §119 to Japanese Patent Application No. 2014-195851, filed Sep. 25, 2014. The contents of this application are incorporated herein by reference in their entirety.

### BACKGROUND

1. Field of the Invention

The embodiments disclosed herein relate to a matrix convertor, a power generation system, and a method for converting power.

2. Discussion of the Background

Japanese Unexamined Patent Application Publication No. 2004-7929 and Japanese Unexamined Patent Application Publication No. 2007-82286 each disclose a matrix convertor that includes a plurality of bidirectional switches to connect input phases to output phases. The matrix convertor controls the bidirectional switches to directly switch the voltages of the input phases so as to output desired voltages and frequencies to the output phases. When the matrix convertor is connected between a power system and a power generator, the input phases are, for example, the R phase, the S phase, and the T phase of the power system, and the output phases are, for example, the U phase, the V phase, and the W phase of the power generator.

In switching the input phases to be connected to the output phases using the bidirectional switches, the matrix convertor performs commutation control. An example of the commutation control is to individually control a plurality of switching elements to be turned on and off in a predetermined order. Although the commutation control prevents short-circuiting between the input phases and prevents the output phases from going into open state, an error may be generated in the output voltage. In view of this, Japanese Unexamined Patent Application Publication No. 2004-7929 and Japanese Unexamined Patent Application Publication No. 2007-82286 suggest techniques of compensating for the error in the output voltage.

### SUMMARY

According to one aspect of the present disclosure, a matrix convertor includes a power convertor, a commutation controller, an error compensator, and a compensation amount adjustor. The power convertor is disposed between a plurality of input phases and a plurality of output phases switchably connected to the plurality of input phases. The power convertor includes a plurality of bidirectional switches each including a plurality of switching elements. The commutation controller is configured to perform commutation control with respect to the plurality of switching elements of each of the plurality of bidirectional switches using a commutation pattern including a plurality of steps so as to switch connection between the plurality of input phases and the plurality of output phases through the power convertor. The error compensator is configured to calculate a compensation amount to decrease an error in an output voltage caused by the commutation control. The compensation amount adjustor is configured to decrease the compensation amount based on at least one voltage among voltages of the plurality of output phases.

According to another aspect of the present disclosure, a power generation system includes a power generator and a matrix convertor. The power generator is configured to generate power. The matrix convertor is connected to the power generator to output the power to a power system. The matrix convertor includes a power convertor, a commutation controller, an error compensator, and a compensation amount adjustor. The power convertor is disposed between a plurality of input phases and a plurality of output phases switchably connected to the plurality of input phases. The power convertor includes a plurality of bidirectional switches each including a plurality of switching elements. The commutation controller is configured to perform commutation control with respect to the plurality of switching elements of each of the plurality of bidirectional switches using a commutation pattern including a plurality of steps so as to switch connection between the plurality of input phases and the plurality of output phases through the power convertor. The error compensator is configured to calculate a compensation amount to decrease an error in an output voltage caused by the commutation control. The compensation amount adjustor is configured to decrease the compensation amount based on at least one voltage among voltages of the plurality of output phases.

According to the other aspect of the present disclosure, a method for converting power includes, when connection between a plurality of input phases and a plurality of output phases is switched through a power convertor including a plurality of bidirectional switches disposed between the plurality of input phases and the plurality of output phases, performing commutation control of controlling switching elements of the plurality of bidirectional switches using a commutation pattern including a plurality of steps. A compensation amount is calculated to decrease an error in an output voltage caused by the commutation control. The compensation amount is decreased based on at least one voltage among voltages of the plurality of output phases.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a diagram illustrating an exemplary configuration of a matrix convertor according to an embodiment;

FIG. 2 is a diagram illustrating an exemplary configuration of a bidirectional switch illustrated in FIG. 1;

FIG. 3 is a diagram illustrating an exemplary configuration of a controller illustrated in FIG. 1;

FIG. 4 illustrates graphs of ON-OFF transitions of switching elements in a case where Io>0 in four-step current commutation;

FIG. 5 illustrates a graph of a PWM control command, an output phase voltage, and a carrier wave in relation to each other in a case where Io>0 in the four-step current commutation;

FIG. 6 illustrates graphs of ON-OFF transitions of switching elements in a case where Io<0 in the four-step current commutation;

FIG. 7 illustrates a graph of the PWM control command, the output phase voltage, and the carrier wave in relation to each other in a case where Io<0 in the four-step current commutation;

FIG. 8 is a diagram illustrating exemplary output voltage space vectors;

FIG. 9 is a diagram illustrating an example of correspondence between an output voltage command and space vectors;

FIG. 10 illustrates a graph of a range within which a compensation amount is decreased;

FIG. 11 is a diagram illustrating an exemplary configuration of a compensation amount adjustor;

FIG. 12 illustrates a graph of an intermediate output phase voltage and an adjustment gain in relation to each other;

FIG. 13 is a diagram illustrating another exemplary configuration of the controller illustrated in FIG. 1; and

FIG. 14 is a flowchart of exemplary power conversion processing performed by the controller.

### DESCRIPTION OF THE EMBODIMENTS

A matrix convertor, a power generation system, and a method for converting power according to embodiments will be described in detail below with reference to the accompanying drawings. The following embodiments are provided for exemplary purposes only and are not intended to limit the present disclosure.

### 1. Configuration of Matrix Convertor

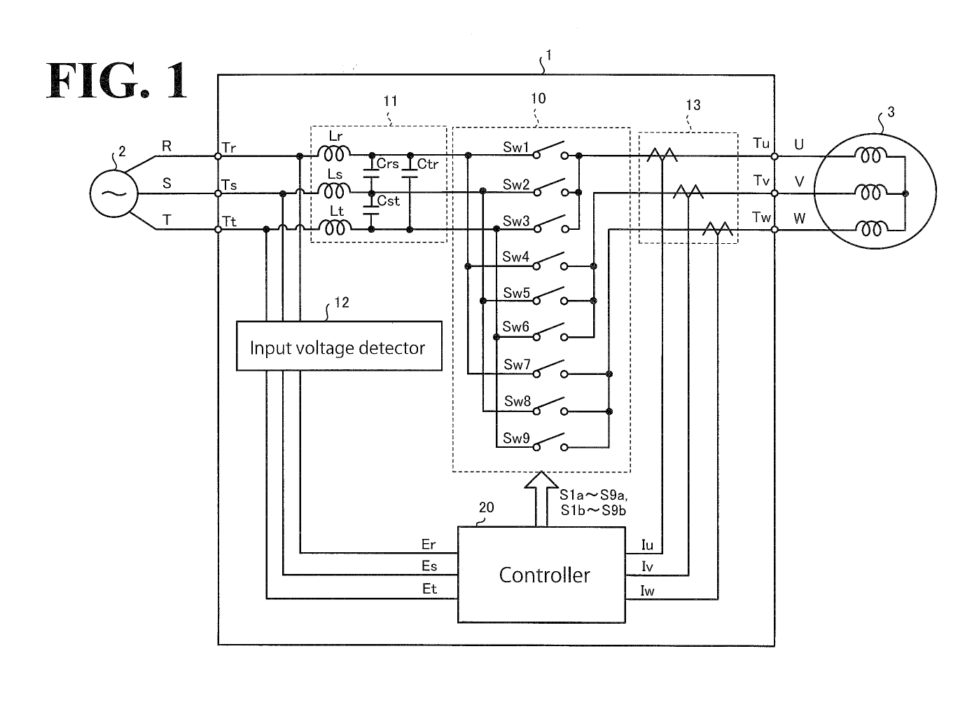

FIG. 1 is a diagram illustrating an exemplary configuration of a matrix convertor according to an embodiment. As illustrated in FIG. 1, the matrix convertor 1 according to this embodiment is disposed between the R phase, the S phase, and the T phase (which are examples of the plurality of input phases) of a three-phase alternating-current (AC) power source 2 (hereinafter referred to as “AC power source 2”) and the U phase, the V phase, and the W phase (which are examples of the output phases) of an AC device 3. Anon-limiting example of the AC power source 2 is a power system. Examples of the AC device 3 include, but are not limited to, rotating electric machines such as AC motors and AC generators.

When the AC power source 2 is a power system and the AC device 3 is an AC generator (which is an example of the power generator), for example, the matrix convertor 1 outputs power generated by the AC device 3 to the AC power source 2. In this case, the matrix convertor 1 and the AC device 3 constitute a power generation system. Alternatively, when the AC power source 2 is a power system and the AC device 3 is an AC motor, the matrix convertor 1 controls the AC device 3 based on power supplied from the AC power source 2.

The matrix convertor 1 includes input terminals Tr, Ts, and Tt, output terminals Tu, Tv, and Tw, a power convertor 10, an LC filter 11, an input voltage detector 12, an output current detector 13, and a controller 20 (which is an example of the controller). A three-phase AC voltage is supplied from the AC power source 2 through the input terminals Tr, Ts, and Tt. The matrix convertor 1 converts the three-phase AC voltage into a desired voltage and frequency, and outputs the voltage and frequency to the AC device 3 through the output terminals Tu, Tv, and Tw.

The power convertor 10 includes a plurality of bidirectional switches Sw1 to Sw9 (hereinafter occasionally referred to as bidirectional switches Sw collectively). The bidirectional switches Sw1 to Sw9 connect each phase of the AC power source 2 and each phase of the AC device 3 to each other.

The bidirectional switches Sw1 to Sw3 respectively connect the R phase, the S phase, and the T phase of the AC power source 2 to the U phase of the AC device 3. The bidirectional switches Sw4 to Sw6 respectively connect the R phase, the S phase, and the T phase of the AC power source 2 to the V phase of the AC device 3. The bidirectional switches Sw7 to Sw9 respectively connect the R phase, the S phase, and the T phase of the AC power source 2 to the W phase of the AC device 3.

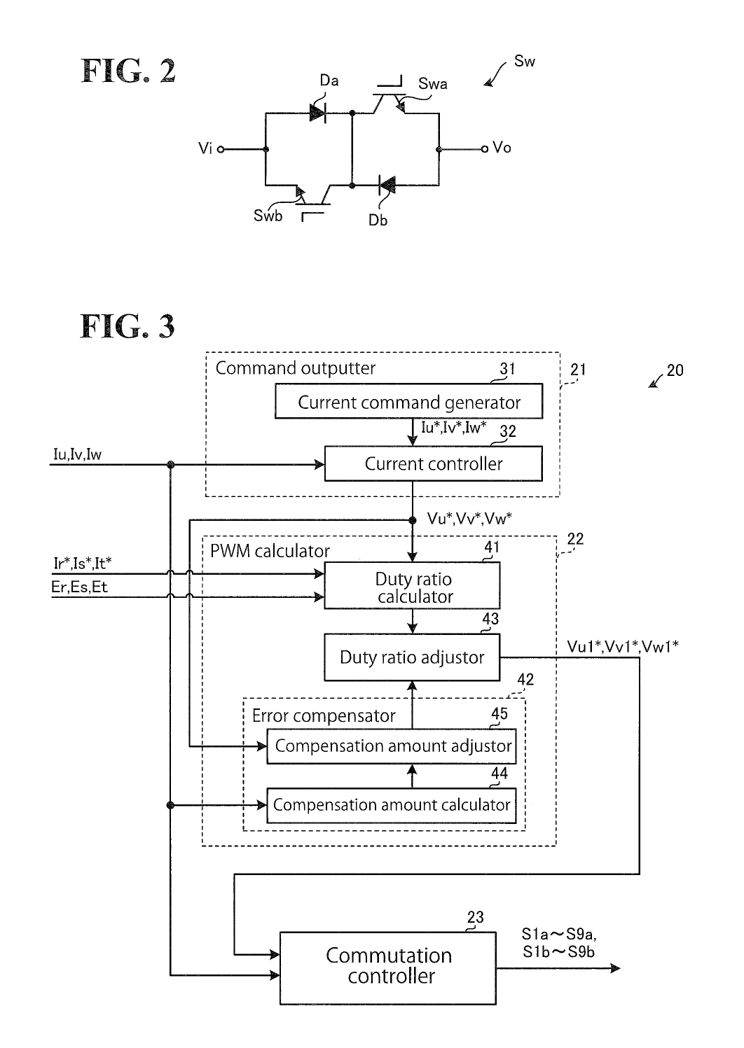

FIG. 2 is a diagram illustrating an exemplary configuration of the bidirectional switch Sw. As illustrated in FIG. 2, the bidirectional switch Sw includes: a series connection circuit of a switching element Swa and a diode Da; and a series connection circuit of a switching element Swb and a diode Db. These series connection circuits are oriented in opposite directions and connected in parallel to each other. In FIG. 2, input phase voltage is indicated as Vi, and output phase voltage is indicated as Vo.

The bidirectional switch Sw will not be limited to the configuration illustrated in FIG. 2; it suffices that the bidirectional switch Sw includes a plurality of switching elements and controls the conduction direction. In the example illustrated in FIG. 2, the cathodes of the diodes Da and Db are connected to each other. The bidirectional switch Sw, however, may have a configuration in which the cathodes of the diodes Da and Db are not connected to each other.

Examples of the switching elements Swa and Swb (hereinafter occasionally referred to as switching elements Swab collectively) include semiconductor switching elements such as metal-oxide-semiconductor field-effect transistors (MOSFETs) and insulated gate bipolar transistors (IGBTs). Other examples of the switching elements Swa and Swb include next-generation semiconductor switching elements such as SiC and GaN. It is noted that when the switching elements Swa and Swb are reverse blocking IGBTs, there is no need for providing the diodes Da and Db.

Referring back to FIG. 1, the matrix convertor 1 will be further described. The LC filter 11 is disposed between the power convertor 10 and the R phase, the S phase, and the T phase of the AC power source 2. The LC filter 11 includes three reactors Lr, Ls, and Lt and three capacitors Crs, Cst, and Ctr, and removes high-frequency components caused by switching of the bidirectional switches Sw.

The input voltage detector 12 detects the voltage of each of the R phase, the S phase, and the T phase of the AC power source 2. For example, the input voltage detector 12 detects instantaneous values Er, Es, and Et of the respective voltages of the R phase, the S phase, and the T phase of the AC power source 2 (the instantaneous values will be hereinafter referred to as input phase voltages Er, Es, and Et).

The output current detector 13 detects a current flowing between the power convertor 10 and the AC device 3. For example, the output current detector 13 detects instantaneous values Iu, Iv, and Iw of currents respectively flowing between the power convertor 10 and the U phase, the V phase, and the W phase of the AC device 3 (hereinafter referred to as output phase currents Iu, Iv, and Iw). In the following description, the output phase currents Iu, Iv, and Iw will be occasionally referred to as output phase currents Io collectively.

Based on values including the input phase voltages Er, Es, and Et and the output phase currents Iu, Iv, and Iw, the controller 20 generates drive signals S1a to S9a and S1b to S9b (hereinafter occasionally referred to as drive signals Sg collectively) to control the bidirectional switches Sw1 to Sw9 of the power convertor 10.

For example, the switching elements Swa of the bidirectional switches Sw1 to Sw9 are respectively driven by the drive signal S1a to S9a, and the switching elements Swb of the bidirectional switches Sw1 to Sw9 are respectively driven by the drive signals S1b to S9b.

### 2. Configuration of Controller 20

FIG. 3 is a diagram illustrating an exemplary configuration of the controller 20. As illustrated in FIG. 3, the controller 20 includes a command outputter 21, a PWM calculator 22, and a commutation controller 23.

The controller 20 includes a microcomputer and various circuits. The microcomputer includes a central processing unit (CPU), a read only memory (ROM), a random access memory (RAM), and input-output ports. The CPU of the microcomputer reads a program stored in the ROM and executes the program so as to function as the command outputter 21, the PWM calculator 22, and the commutation controller 23. It is noted that the controller 20 may be made up of hardware alone, without any programs.

The command outputter 21 generates and outputs output voltage commands Vu*, Vv*, and Vw* of the respective output phases at predetermined control intervals. The command outputter 21 includes a current command generator 31 and a current controller 32.

The current command generator 31 generates output current commands Iu*, Iv*, and Iw* based on, for example, a frequency command f*. The current command generator 31 may generate the output current commands Iu*, Iv*, and Iw* based on a torque command T*, instead of the frequency command f*.

Based on the output current commands Iu*, Iv*, and Iw*, and based on the output phase currents Iu, Iv, and Iw, the current controller 32 generates and outputs the output voltage commands Vu*, Vv*, and Vw* of the respective output phases at predetermined control intervals. For example, for the U phase, the current controller 32 performs proportional integral (PI) control to make the difference between the output current command Iu* and the output phase current Iu zero, so as to generate the output voltage command Vu*. Similarly, for the V phase and the W phase, the current controller 32 performs the PI control, for example, to generate the output voltage commands Vv* and Vw*.

Based on the output voltage commands Vu*, Vv*, and Vw*, the PWM calculator 22 generates PWM control commands Vu1*, Vv1*, and Vw1* (hereinafter occasionally referred to as PWM control commands Vo1* collectively) to specify a duty ratio for pulse width modulation (PWM) control. The PWM calculator 22 outputs the PWM control commands Vo1* to the commutation controller 23.

When the PWM control commands Vo1* are changed, the commutation controller 23 performs commutation control processing of a commutation pattern including two or more steps to generate drive signals Sg. Thus, the switching elements Swab constituting the bidirectional switches Sw are individually switched in a predetermined order to eliminate or minimize a line-to-line short-circuiting of the AC power source 2 and output opening of the matrix convertor 1. The commutation controller 23 and the PWM calculator 22 will be described in more detail in this order below.

### 3. Commutation Controller 23

Examples of the commutation performed by the commutation controller 23 include, but are not limited to, current commutation and voltage commutation. The current commutation is a method of commutation performed for each output phase in a commutation pattern that accords with the polarity of the output phase current Io.

Thus, the switching elements Swab constituting the bidirectional switch Sw are individually switched on and off in a predetermined order. This configuration eliminates or minimizes line-to-line short-circuiting in the AC power source 2, and eliminates or minimizes opening of the output phases of the matrix convertor 1. Four-step current commutation will be described below as an example of the current commutation performed by the commutation controller 23.

In order to prevent line-to-line short-circuiting and prevent opening of the output phases, the commutation control using the four-step current commutation is based on a commutation pattern that accords with the polarity of the output phase current Io. The commutation pattern includes the following first to fourth steps:

Step 1: Among the switching elements Swab constituting the bidirectional switches Sw in the switching source, turn OFF a switching element whose conduction direction has an opposite polarity to the polarity of the output phase current Io;

Step 2: Among the switching elements Swab constituting the bidirectional switches Sw in the switching destination, turn ON a switching element whose conduction direction has the same polarity as the polarity of the output phase current Io;

Step 3: Among the switching elements Swab constituting the bidirectional switches Sw in the switching source, turn OFF a switching element whose conduction direction has the same polarity as the polarity of the output phase current Io; and

Step 4: Among the switching elements Swab constituting the bidirectional switches Sw in the switching destination, turn ON a switching element whose conduction direction has an opposite polarity to the polarity of the output phase current Io.

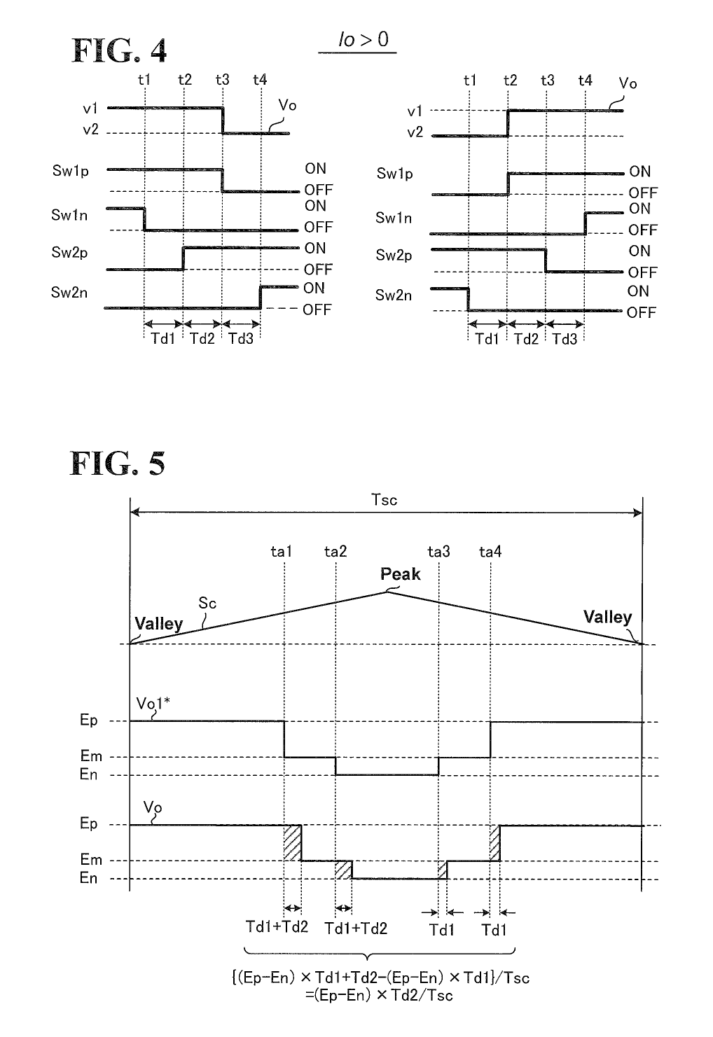

FIG. 4 illustrates graphs of ON-OFF transitions of switching elements in a case where Io>0 in the four-step current commutation. Switching elements Sw1p and Sw1n are respectively switching elements Swa and Swb of a bidirectional switch Sw connected to an input phase voltage v1. Switching elements Sw2p and Sw2n are respectively switching elements Swa and Swb of a bidirectional switch Sw connected to an input phase voltage v2. The voltages v1 and v2 are the input phase voltages Vi and in the relationship: v1>v2.

As illustrated in FIG. 4, in the case where Io>0 and the input phase voltage V changes from v1 to v2, the output phase voltage Vo changes at the timing (timing t3) of the third step. Alternatively, in the case where Io>0 and the input phase voltage Vi changes from v2 to v1, the output phase voltage Vo changes at the timing (timing t2) of the second step.

FIG. 5 illustrates a graph of the PWM control command Vo1*, the output phase voltage Vo, and a carrier wave Sc in relation to each other in a case where Io>0 in the four-step current commutation. As illustrated in FIG. 5, the output phase voltage Vo does not change at the switching timing of the input phase voltage Vi specified by the PWM control command Vo1*.

Specifically, as illustrated in FIG. 5, the output phase voltage Vo changes at the timing (Td1+Td2) of the third step past timing ta1 and timing ta2. The output phase voltage Vo changes at the timing (Td1) of the second step past timing ta3 and timing ta4. Consequently, in one cycle Tsc of the carrier wave Sc, an error (Ep−En)×Td2/Tsc is generated in the output phase voltage Vo with respect to the PWM control command Vo1*.

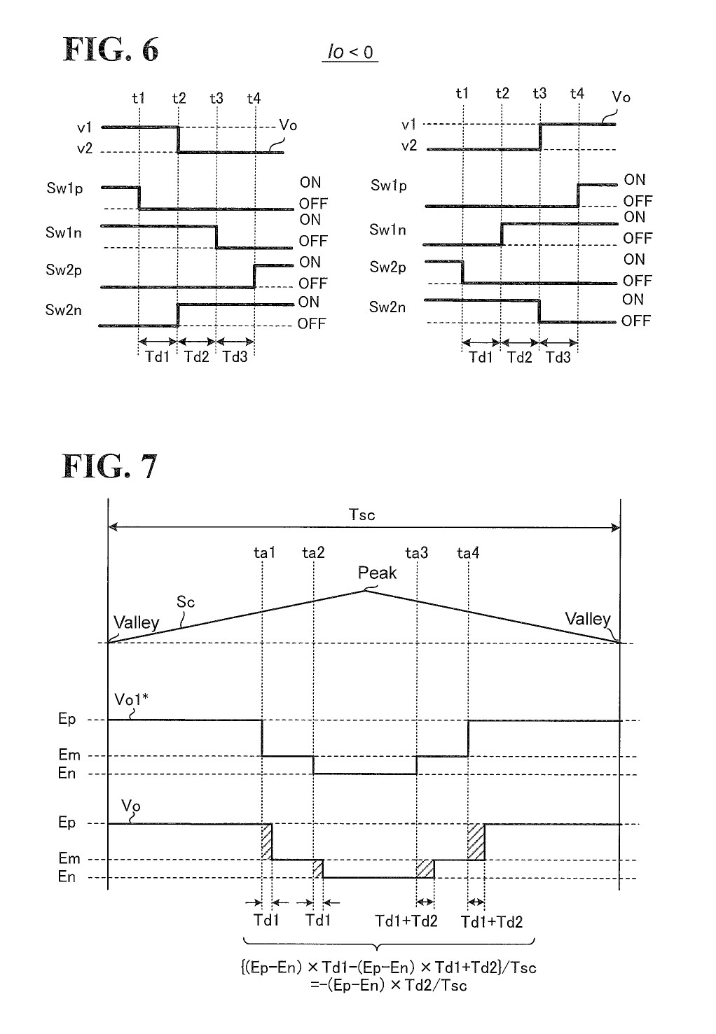

In contrast, in a case where Io<0, the input phase voltage Vi output to the output phase changes at different timings from the timings in the case where Io>0. FIG. 6 illustrates graphs of ON-OFF transitions of switching elements in the case where Io<0 in the four-step current commutation.

As illustrated in FIG. 6, in the case where Io<0 and the input phase voltage Vi changes from v1 to v2, the output phase voltage Vo changes at the timing (timing t2) of the second step. Alternatively, in the case where Io<0 and the input phase voltage Vi changes from v2 to v1, the output phase voltage Vo changes at the timing (timing t3) of the third step.

FIG. 7 illustrates a graph of the PWM control command Vo1*, the output phase voltage Vo, and the carrier wave Sc in relation to each other in a case where Io<0 in the four-step current commutation. As illustrated in FIG. 7, in the case where Io<0, similarly to the case where Io>0, the output phase voltage Vo does not change at the switching timing of the input phase voltage Vi specified by the PWM control command Vo1*.

Specifically, the output phase voltage Vo changes at the timing (Td1) of the second step past timing ta1 and timing ta2. The output phase voltage Vo changes at the timing (Td1+Td2) of the third step past timing ta3 and timing ta4. Consequently, in one cycle Tsc of the carrier wave Sc, an error of “−(Ep−En)×Td2/Tsc” is generated in the output phase voltage Vo with respect to the PWM control command Vo1*.

In this manner, in the commutation control using the current commutation, the timing at which the output phase voltage Vo changes varies depending on whether the voltage increases (v2→v1) or the voltage decreases (v1→v2). The variation causes an error (hereinafter referred to as output voltage error Voerr) in the output phase voltage Vo with respect to the PWM control command Vo1*. Also, the polarity of the output voltage error Voerr depends on the polarity of the output phase current Io. It is noted that although the four-step current commutation has been described so far, an output voltage error Voerr is also generated in any other commutation performed by the commutation controller 23.

While performing the commutation control using the current commutation, the commutation controller 23 may occasionally be instructed by the PWM control command Vo1* to perform the next commutation control. In this case, it is possible for the commutation controller 23 to perform the next commutation control in the middle of the commutation control in progress. When the commutation controller 23 performs the next commutation control in the middle of the commutation control in progress, the commutation controller 23 performs, for example, a transfer step for turning on one unidirectional switch constituting a switching-destination bidirectional switch Sw in the next commutation control. This configuration eliminates or minimizes a commutation failure such as opening of the output phases, and ensures accurate transfer between the commutation control operations. In the following description, the processing for performing the next commutation control in the middle of the commutation control in progress will be occasionally referred to as commutation skip processing.

### 4. PWM Calculator 22

The PWM calculator 22 calculates a duty ratio of the PWM control using either a space vector method or a carrier comparison method. Based on a result of the calculation, the PWM calculator 22 generates PWM control commands Vu1*, Vv1*, and Vw1*.

An example of the PWM calculator 22 generating the PWM control commands Vu1*, Vv1*, and Vw1* using the space vector method will now be described. As illustrated in FIG. 3, the PWM calculator 22 includes a duty ratio calculator 41 (which is an example of the command generator), an error compensator 42, and a duty ratio adjustor 43.

Based on values including the input phase voltages Er, Es, and Et, the output voltage commands Vu*, Vv*, and Vw*, and input current commands Ir*, Is*, and It*, the duty ratio calculator 41 calculates an output vector ratio indicating the duty ratio of the PWM control in every half-cycle of the carrier wave Sc using the space vector method. The calculation using the space vector method may be based on the conventional, known technique disclosed in WO 2006/118026, for example.

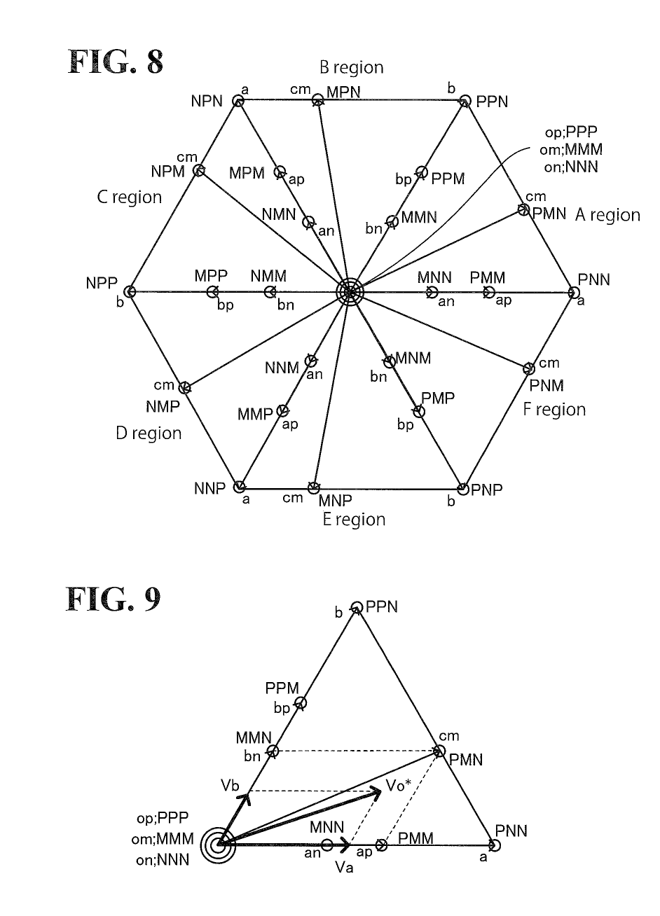

The space vector method will now be described. For the R phase, the S phase, and the T phase of the AC power source 2, assume that the maximum voltage phase is represented by P, the minimum voltage phase is represented by N, and the intermediate voltage phase is represented by M. In this case, the space vectors of the output voltages can be represented as in FIG. 8. FIG. 8 is a diagram illustrating exemplary space vectors of the output voltages.

Referring to FIG. 8, “a-vector” is a vector term indicating a state in which one of the output phases, namely, the U phase, the V phase, and the W phase, is connected to the maximum voltage phase P, and in which the rest of the output phases are connected to the minimum voltage phase N. “b-vector” represents a state in which one of the output phases is connected to the minimum voltage phase N, and in which the rest of the output phases are connected to the maximum voltage phase P. Among the output voltage commands Vu*, Vv*, and Vw*, the maximum value is represented by Vmax, the intermediate value is represented by Vmid, and the minimum value is represented by Vmin. When the output phase of the maximum value Vmax is connected to the maximum voltage phase P, the output phase of the intermediate value Vmid is connected to the minimum voltage phase N, and the output phase of the minimum value Vmin is connected to the minimum voltage phase N, this state is represented by “PNN”, which is an “a-vector”. Similarly, “NPN” and “NNP” are “a-vectors”. “PPN”, “PNP”, and “NPP” are “b-vectors”.

As used herein, “ap-vector”, “an-vector”, “bp-vector”, and “bn-vector” indicate states in which at least one of the output phases is connected to the intermediate voltage phase M. “cm-vectors” indicate states in which the U phase, the V phase, and the W phase are each connected to a different input phase. “on-vector”, “om-vector”, and “op-vector” indicate states in which the U phase, the V phase, and the W phase are all connected to an identical input phase.

FIG. 9 is a diagram illustrating an example of correspondence between an output voltage command Vo* and space vectors. As illustrated in FIG. 9, the PWM calculator 22 uses a switching pattern of a combination of a plurality of output vectors to turn an “a-vector component Va” and a “b-vector component Vb” of the output voltage command Vo* into the PWM control commands Vu1*, Vv1*, and Vw1*. Then, the PWM calculator 22 outputs the PWM control commands Vu1*, Vv1*, and Vw1*.

The duty ratio calculator 41 regards the input phase voltages Er, Es, and Et as input phase voltages Ep, Em, and En in descending order of magnitude. Among the output voltage commands Vu*, Vv*, and Vw*, the duty ratio calculator 41 regards the maximum value as Vmax, the intermediate value as Vmid, and the minimum value as Vmin. Then, the duty ratio calculator 41 calculates the a-vector component Va and the b-vector component Vb based on the following Formulae (1) and (2), for example:

|Va|=Vmax−Vmid (1)

|Vb|=Vmid−Vmin (2)

The duty ratio calculator 41 regards the input phase voltage Vi, which has the largest absolute value among the input phase voltages Er, Es, and Et, as a reference voltage Ebase. When the reference voltage Ebase is Ep, the duty ratio calculator 41 calculates a current division ratio α based on the following Formula (3), for example. When the reference voltage Ebase is En, the duty ratio calculator 41 calculates the current division ratio α based on the following Formula (4), for example. In the following Formulae (3) and (4), among the input current commands Ir*, Is*, and It*, current command values of the phases corresponding to the input phase voltages Ep, Em, and En are respectively represented by Ip, Im, and In:

α=Im/In (3)

α=Im/Ip (4)

In an input power control section (not illustrated) of the controller 20, the input current commands Ir*, Is*, and It* are generated based on, for example, a positive-phase-sequence component voltage, a negative-phase-sequence component voltage, and a set power factor command. The input current commands Ir*, Is*, and It* cancel the influence of imbalance voltage and also control the power factor of the input current at a desired value.

The duty ratio calculator 41 selects one switching pattern from among a plurality of switching patterns. The following Table 1 shows exemplary switching patterns. For example, based on whether the reference voltage Ebase is the input phase voltage Ep or En, and based on whether |Vb|−α|Va|>0 is satisfied, the duty ratio calculator 41 selects one switching pattern from among the switching patterns shown in Table 1. The duty ratio calculator 41 calculates a ratio of each of the output vectors constituting the selected switching pattern based on the output voltage commands Vu*, Vv*, and Vw*.

TABLE 1

| | Switching Pattern | | |
|---|---|---|---|
| | Carrier Half-Cycle | Carrier Half-Cycle | Pattern |
| Condition | (Valley → Peak) | (Peak → Valley) | Number |
| Ebase ≧ 0, | op → bp → b → | a → cm → b → | 1 |
| \|Vb\| − α\|Va\| ≧ 0 | cm → a | bp → op | |
| Ebase ≧ 0, | op → bp → ap → | a → cm → ap → | 2 |
| \|Vb\| − α\|Va\| < 0 | cm → a | bp → op | |
| Ebase < 0, | b → cm → a → | on → an → a → | 3 |
| \|Vb\| − α\|Va\| ≧ 0 | an → on | cm → b | |
| Ebase < 0, | a → cm → bn → | on → an → bn → | 4 |
| \|Vb\| − α\|Va\| < 0 | an → on | cm → a | |

The error compensator 42 calculates a compensation amount for compensating for the output voltage error Voerr. The error compensator 42 includes a compensation amount calculator 44 and a compensation amount adjustor 45. Based on, for example, the polarity of the output phase current Io, commutation periods of time Td1 and Td2, and the number of peaks and valleys of the carrier wave Sc in a correction amount calculation cycle Tc, the compensation amount calculator 44 calculates a compensation amount Tcp(max), a compensation amount Tcp(mid), and a compensation amount Tcp(min).

Tcp(max) is a compensation amount with respect to the maximum output voltage phase, Tcp(mid) is a compensation amount with respect to the intermediate output voltage phase, and Tcp(min) is a compensation amount with respect to the minimum output voltage phase. The maximum output voltage phase is an output phase corresponding to Vmax, the intermediate output voltage phase is an output phase corresponding to Vmid, and the minimum output voltage phase is an output phase corresponding to Vmin. In the following description, Tcp(max), Tcp(mid), and Tcp(min) will be collectively referred to as Tcp(o). The number of peaks, the number of valleys, and the number of peaks and valleys of the carrier wave Sc in the correction amount calculation cycle Tc will be respectively referred to as Cy, Ct, and Cyt. It is noted that when a period from a valley to a peak is the correction amount calculation cycle Tc, then Ct=1, and Cyt=1. When a period from a peak to a valley is the correction amount calculation cycle Tc, then Cy=1, and Cyt=1.

The correction amount calculation cycle Tc is equal to the calculation cycle of the output voltage command Vo* calculated by the command outputter 21. This configuration ensures that the compensation amount Tcp(o) is calculated in every calculation cycle of the output voltage command Vo*. This improves accuracy of the compensation amount Tcp(o). It is noted that the correction amount calculation cycle Tc may be 1/n (n is a natural number) of the calculation cycle of the output voltage command Vo*.

When the current commutation is employed and when the polarity of the output phase current Io is positive, or when the voltage commutation is employed and when the polarity of the output phase current Io is not positive, the compensation amount calculator 44 calculates the compensation amount Tcp(o) using the following Formula (5), for example:

$$Tcp ( o ) = \frac{( Td 1 + Td 2 ) \cdot Ct - Td 1 \cdot Cy}{Cyt} \qquad ( 5 )$$

When the current commutation is employed and when the polarity of the output phase current Io is not positive, or when the voltage commutation is employed and when the polarity of the output phase current Io is positive, the compensation amount calculator 44 calculates the compensation amount Tcp(o) using the following Formula (6), for example:

$$Tcp ( o ) = \frac{Td 1 \cdot Ct - ( Td 1 + Td 2 ) \cdot Cy}{Cyt} \qquad ( 6 )$$

When the compensation amount Tcp(o) is set, and when, for example, an instantaneous voltage of the input phase is low, then an overcompensation may occur with respect to the output voltage error Voerr. For example, an overcompensation may occur when the above-described commutation skip processing is performed or when the output vector ratio is so small that it is impossible to output to the output phase an input phase voltage Vi that accords with the output vector.

The overcompensation may cause, for example, current ripples to increase each having a component six times the output frequency. The increased current ripples may cause the output property to degrade. In view of the possible degradation, based on the input phase voltages Er, Es, and Et, the compensation amount adjustor 45 adjusts the compensation amount Tcp(o) calculated by the compensation amount calculator 44.

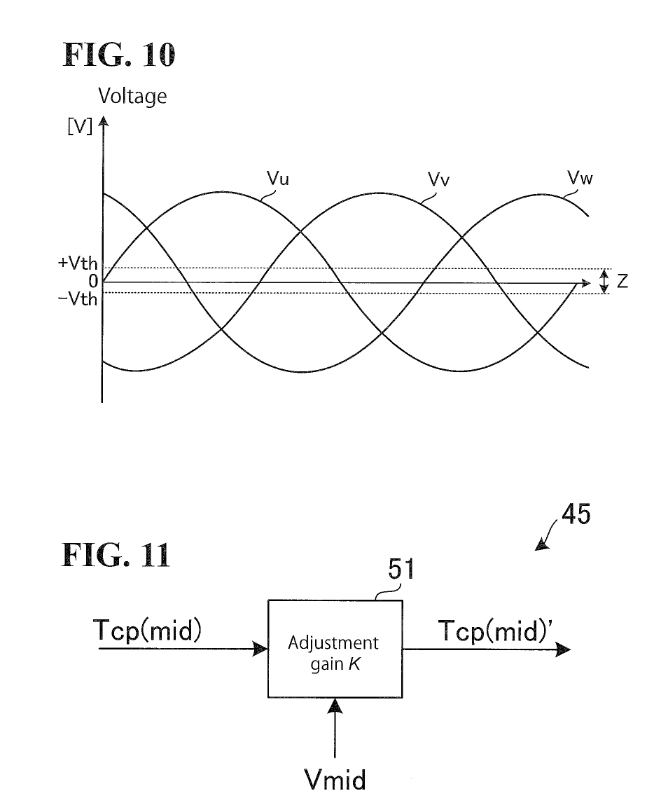

For example, when the intermediate voltage among the plurality of output phase voltages Vu, Vv, and Vw is within a predetermined range Z, which includes zero, the compensation amount adjustor 45 decreases the compensation amount in accordance with the intermediate voltage. As illustrated in FIG. 10, the predetermined range Z is a range in which the output phase voltages Vu, Vv, and Vw are from +Vth to −Vth. FIG. 10 illustrates a graph of the range within which the compensation amount Tcp(o) is decreased.

The output phase voltages Vi, Vv, and Vw are respectively generated based on the output voltage commands Vu*, Vv*, and Vw*. Consequently, when the intermediate value Vmid (hereinafter referred to as intermediate output phase voltage Vmid) among the output voltage commands Vu*, Vv*, and Vw* is within the predetermined range Z, the compensation amount adjustor 45 decreases the compensation amount Tcp(o) in accordance with the intermediate voltage. The compensation amount adjustor 45 is also capable of determining whether the intermediate output phase voltage Vmid is within the predetermined range Z based on the phase of one of the output voltage commands Vu*, Vv*, and Vw*.

For example, when the intermediate output phase voltage Vmid is within the predetermined range Z, the compensation amount adjustor 45 adjusts the compensation amount Tcp(mid) with respect to the intermediate output phase voltage Vmid.

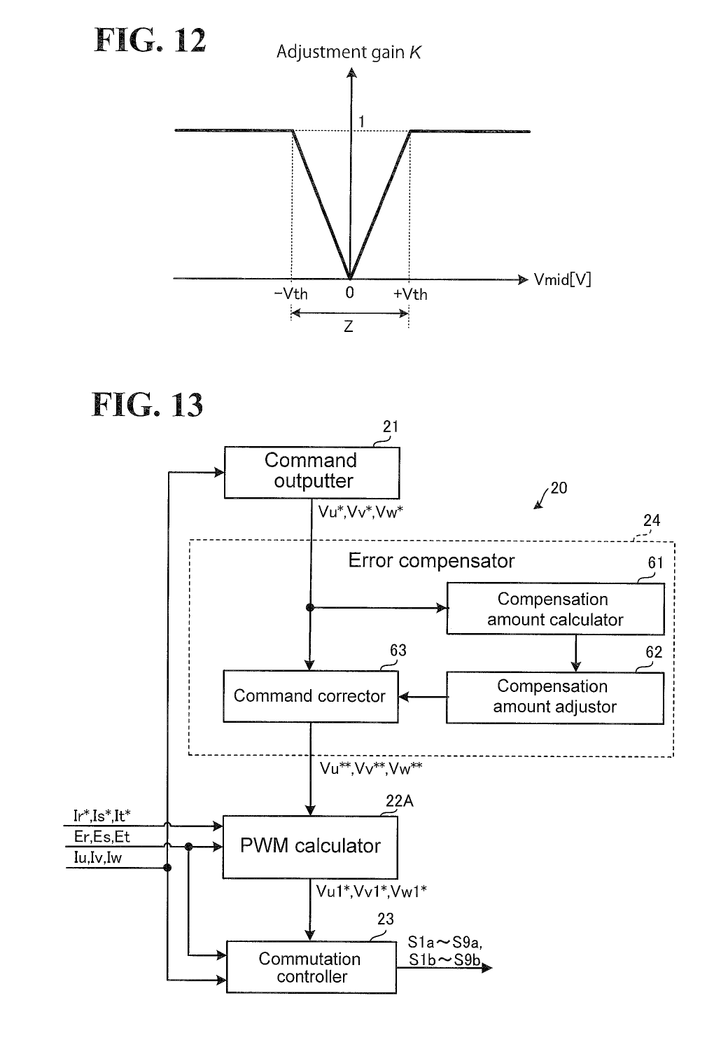

FIG. 11 is a diagram illustrating an exemplary configuration of the compensation amount adjustor 45. FIG. 12 illustrates a graph of the intermediate output phase voltage Vmid and an adjustment gain in relation to each other. As illustrated in FIG. 11, the compensation amount adjustor 45 includes a multiplier 51. The multiplier 51 multiplies the compensation amount Tcp(mid) by an adjustment gain K. As illustrated in FIG. 12, the adjustment gain K decreases as the intermediate output phase voltage Vmid decreases within the predetermined range Z, and the adjustment gain K is “1” when the intermediate output phase voltage Vmid is outside the predetermined range Z. In FIG. 11, the compensation amount Tcp(mid) multiplied by the adjustment gain K is indicated as a compensation amount Tcp(mid)′.

Thus, when the intermediate output phase voltage Vmid is within the predetermined range Z, the compensation amount adjustor 45 is capable of decreasing the adjustment gain K with respect to the compensation amount Tcp(mid) of the intermediate output phase voltage Vmid as the intermediate output phase voltage Vmid decreases. That is, the compensation amount adjustor 45 is capable of increasing the rate of decreasing the compensation amount Tcp(mid) as the intermediate output phase voltage Vmid decreases.

Thus, when the intermediate output phase voltage Vmid is low, the compensation amount Tcp(mid) is decreased. This configuration eliminates or minimizes overcompensation. With no or minimal overcompensation, the accuracy of the output property of the matrix convertor improves.

The adjustment gain K illustrated in FIG. 12 decreases in proportion to the intermediate output phase voltage Vmid within the predetermined range Z. The adjustment gain K, however, will not be limited to the example illustrated in FIG. 12. Another possible embodiment is that the adjustment gain K decreases at stages. Another possible embodiment is that the adjustment gain K has two stages within the predetermined range Z. While in the above-described embodiment the compensation amount Tcp(mid) is adjusted with the intermediate output phase voltage Vmid in focus, this embodiment should not be construed in a limiting sense. The compensation amount adjustor 45 may have any other configuration insofar as the compensation amount adjustor 45 adjusts the compensation amount Tcp(o) when an overcompensation occurs due to the state of the output phase voltage Vo.

Based on the compensation amount Tcp(o), the duty ratio adjustor 43 adjusts some of the output vector ratios calculated for the output phases. Then, based on the output vector ratios subjected to the adjustment, the duty ratio adjustor 43 generates the PWM control commands Vu1*, Vv1*, and Vw1*. Then, the duty ratio adjustor 43 outputs the generated PWM control commands Vu1*, Vv1*, and Vw1* to the commutation controller 23.

The PWM calculator 22 includes the error compensator 42. In order to decrease the output voltage error Voerr caused by the commutation control, the error compensator 42 corrects the duty ratio of the PWM pulse obtained from the output voltage command Vo* to generate the PWM control command Vo1*. The error compensator 42 includes the compensation amount calculator 44 and the compensation amount adjustor 45. The compensation amount calculator 44 calculates the compensation amount to decrease the error in the output voltage caused by the commutation control. The compensation amount adjustor 45 decreases the compensation amount based on the output phase voltage Vo. Consequently, the matrix convertor 1 according to this embodiment accurately eliminates or minimizes the output voltage error Voerr caused by the commutation control without correcting the output voltage command Vo*. The matrix convertor 1 also eliminates or minimizes degradation of the output property of the matrix convertor caused by overcompensation.

In the above-described embodiment, the space vector method is used in the PWM calculator 22 to generate the PWM control command Vo1*. Another possible embodiment is to use a triangular wave comparison method to generate the PWM control command Vo1*. In the case of the triangular wave comparison method as well, the PWM calculator 22 calculates the compensation amount Tcp(o) corresponding to the output voltage error Voerr caused by the commutation control, and decreases the compensation amount Tcp(o) based on the output phase voltage Vo. This configuration accurately eliminates or minimizes the output voltage error Voerr caused by the commutation control without correcting the output voltage commands Vu*, Vv*, and Vw*, and eliminates or minimizes degradation of the output property of the matrix convertor caused by overcompensation.

In generating the PWM control command Vo1*, the PWM calculator 22 may also select from the space vector method and the triangular wave comparison method based on information input by the user or installer through an inputting device (not illustrated) of the matrix convertor 1.

In the above description, the compensation amount Tcp(o), which is for compensating for the output vector ratio, is adjusted in accordance with the state of the output voltage. Another possible embodiment is illustrated in FIG. 13, where a compensation amount for compensating for the output phase voltage command Vo* is adjusted in accordance with the state of the output voltage. FIG. 13 is a diagram illustrating another exemplary configuration of the controller 20. The controller 20 illustrated in FIG. 13 includes a compensation amount calculator 61, a compensation amount adjustor 62, and a command corrector 63.

Similarly to the compensation amount calculator 44, the compensation amount calculator 61 calculates compensation amounts Tcp(max), Tcp(mid), and Tcp(min). The compensation amount calculator 61 further calculates voltage command compensation amounts Vcp(max), Vcp(mid), and Vcp(min). The voltage command compensation amounts Vcp(max), Vcp(mid), and Vcp(min) respectively correspond to the compensation amounts Tcp(max), Tcp(mid), and Tcp(min). For example, the compensation amount calculator 61 multiplies the compensation amounts Tcp(max), Tcp(mid), and Tcp(min) individually by (Ep−En)/Tsc to obtain the voltage command compensation amounts Vcp(max), Vcp(mid), and Vcp(min).

Similarly to the compensation amount adjustor 45, the compensation amount adjustor 62 multiplies the compensation amount Vcp(mid) by the adjustment gain K to adjust the compensation amount Vcp(mid). The command corrector 63 adds Vcp(max) to the output voltage command Vo* of the maximum value Vmax, adds Vcp(mid) obtained from the compensation amount adjustor 62 to the output voltage command Vo* of the intermediate value Vmid, and adds Vcp(min) to the output voltage command Vo* of the minimum value Vmin. The command corrector 63 regards the corrected output voltage commands, Vo*, as output voltage commands Vo** (Vu**, Vv**, and Vw**), and outputs the output voltage commands Vo** to the PWM calculator 22A.

The PWM calculators 22 and 22A may select from two-phase modulation and three-phase modulation, and generate the PWM control command Vo1* using the selected modulation. The two-phase modulation is a method of connecting one of the output phases to one of the input phases and modulating each of the rest of the output phases using all the three input phases. The three-phase modulation is a method of modulating each of all the output phases using all the input phases. In the case of the two-phase modulation, the error compensators 42 and 24 do not perform compensation with respect to the output phase to which PWM modulation is not performed. That is, in the case of the two-phase modulation, the error compensators 42 and 24 do not perform compensation with respect to the output voltage command Vo* of the maximum value Vmax.

### 5. Processing Flow

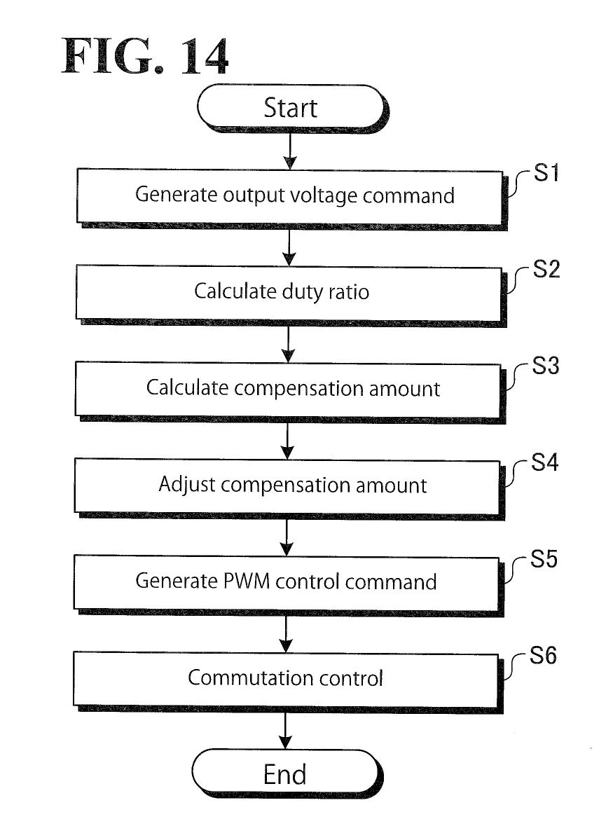

By referring to FIG. 14, an exemplary flow of power conversion processing performed by the controller 20 will now be described in detail below. FIG. 14 is a flowchart of the exemplary power conversion processing performed by the controller 20.

As illustrated in FIG. 14, the command outputter 21 of the controller 20 generates and outputs the output voltage commands Vu*, Vv*, and Vw* (step S1). Based on the output voltage commands Vu*, Vv*, and Vw*, the duty ratio calculator 41 of the PWM calculator 22 calculates output vector ratios specifying the duty ratio of the PWM control (step S2). The error compensator 42 of the PWM calculator 22 calculates a compensation amount for compensating for the output voltage error Voerr (step S3).

The compensation amount adjustor 45 of the PWM calculator 22 adjusts the compensation amount based on the states of the plurality of output phase voltages Vu, Vv, and Vw (step S4). For example, when the intermediate output phase voltage Vmid is within the predetermined range Z, which includes zero, the compensation amount adjustor 45 decreases the compensation amount in accordance with the intermediate output phase voltage Vmid.

Based on the compensation amount, the duty ratio adjustor 43 of the PWM calculator 22 adjusts some of the output vector ratios calculated by the duty ratio calculator 41. Then, based on the output vector ratios subjected to the adjustment, the duty ratio adjustor 43 generates the PWM control command Vo1* (step S5). When the PWM control command Vo1* is changed, the commutation controller 23 performs commutation control processing using predetermined commutation including one or more steps so as to generate a drive signal Sg (step S6).

As has been described heretofore, the matrix convertor 1 according to this embodiment adjusts the compensation amount based on the states of the plurality of output phase voltages Vu, Vv, and Vw. This configuration ensures appropriate adjustment of the compensation amount for compensating for the output voltage error Voerr. This eliminates or minimizes degradation of the output property of the matrix convertor.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A matrix convertor comprising:
a power convertor disposed between a plurality of input phases and a plurality of output phases switchably connected to the plurality of input phases, the power convertor comprising a plurality of bidirectional switches each comprising a plurality of switching elements;
a commutation controller configured to perform commutation control with respect to the plurality of switching elements of each of the plurality of bidirectional switches using a commutation pattern comprising a plurality of steps so as to switch connection between the plurality of input phases and the plurality of output phases through the power convertor;
an error compensator configured to calculate a compensation amount to decrease an error in an output voltage caused by the commutation control; and
a compensation amount adjustor configured to decrease the compensation amount based on at least one voltage among voltages of the plurality of output phases.

2. The matrix convertor according to claim 1,
wherein the error compensator is configured to calculate the compensation amount for each of the plurality of output phases, and
wherein when an intermediate voltage among the voltages of the plurality of output phases is within a predetermined range comprising zero, the compensation amount adjustor is configured to decrease the compensation amount corresponding to the intermediate voltage.

3. The matrix convertor according to claim 2, wherein the compensation amount adjustor is configured to increase a decrease rate of the compensation amount as the intermediate voltage decreases.

4. The matrix convertor according to claim 1, further comprising:
a duty ratio calculator configured to calculate a duty ratio of PWM control with respect to the power convertor; and
a duty ratio adjustor configured to, based on the compensation amount output from the compensation amount adjustor, adjust the duty ratio and generate a PWM control command,
wherein the commutation controller is configured to perform the commutation control based on the PWM control command.

5. The matrix convertor according to claim 1, further comprising:
a command outputter configured to output an output voltage command;
a command corrector configured to correct the output voltage command based on the compensation amount; and
a PWM calculator configured to, based on the output voltage command corrected by the command corrector, calculate a control command for PWM control with respect to the power convertor.

6. A power generation system comprising:
a power generator configured to generate power; and
a matrix convertor connected to the power generator to output the power to a power system, the matrix convertor comprising:
a power convertor disposed between a plurality of input phases and a plurality of output phases switchably connected to the plurality of input phases, the power convertor comprising a plurality of bidirectional switches each comprising a plurality of switching elements;
a commutation controller configured to perform commutation control with respect to the plurality of switching elements of each of the plurality of bidirectional switches using a commutation pattern comprising a plurality of steps so as to switch connection between the plurality of input phases and the plurality of output phases through the power convertor;
an error compensator configured to calculate a compensation amount to decrease an error in an output voltage caused by the commutation control; and
a compensation amount adjustor configured to decrease the compensation amount based on at least one voltage among voltages of the plurality of output phases.

7. A method for converting power, the method comprising:
when connection between a plurality of input phases and a plurality of output phases is switched through a power convertor comprising a plurality of bidirectional switches disposed between the plurality of input phases and the plurality of output phases, performing commutation control of controlling switching elements of the plurality of bidirectional switches using a commutation pattern comprising a plurality of steps;
calculating a compensation amount to decrease an error in an output voltage caused by the commutation control; and
decreasing the compensation amount based on at least one voltage among voltages of the plurality of output phases.

8. The matrix convertor according to claim 2, further comprising:
a duty ratio calculator configured to calculate a duty ratio of PWM control with respect to the power convertor; and
a duty ratio adjustor configured to, based on the compensation amount output from the compensation amount adjustor, adjust the duty ratio and generate a PWM control command,
wherein the commutation controller is configured to perform the commutation control based on the PWM control command.

9. The matrix convertor according to claim 3, further comprising:
a duty ratio calculator configured to calculate a duty ratio of PWM control with respect to the power convertor; and
a duty ratio adjustor configured to, based on the compensation amount output from the compensation amount adjustor, adjust the duty ratio and generate a PWM control command,
wherein the commutation controller is configured to perform the commutation control based on the PWM control command.

10. The matrix convertor according to claim 2, further comprising:
a command outputter configured to output an output voltage command;
a command corrector configured to correct the output voltage command based on the compensation amount; and
a PWM calculator configured to, based on the output voltage command corrected by the command corrector, calculate a control command for PWM control with respect to the power convertor.

11. The matrix convertor according to claim 3, further comprising:
a command outputter configured to output an output voltage command;
a command corrector configured to correct the output voltage command based on the compensation amount; and
a PWM calculator configured to, based on the output voltage command corrected by the command corrector, calculate a control command for PWM control with respect to the power convertor.

12. The matrix convertor according to claim 4, further comprising:
a command outputter configured to output an output voltage command;
a command corrector configured to correct the output voltage command based on the compensation amount; and
a PWM calculator configured to, based on the output voltage command corrected by the command corrector, calculate a control command for PWM control with respect to the power convertor.

13. The matrix convertor according to claim 8, further comprising:
a command outputter configured to output an output voltage command;
a command corrector configured to correct the output voltage command based on the compensation amount; and
a PWM calculator configured to, based on the output voltage command corrected by the command corrector, calculate a control command for PWM control with respect to the power convertor.

14. The matrix convertor according to claim 9, further comprising:
a command outputter configured to output an output voltage command;
a command corrector configured to correct the output voltage command based on the compensation amount; and
a PWM calculator configured to, based on the output voltage command corrected by the command corrector, calculate a control command for PWM control with respect to the power convertor.

15. A matrix convertor comprising:
a power convertor disposed between a plurality of input phases and a plurality of output phases switchably connected to the plurality of input phases, the power convertor comprising a plurality of bidirectional switches each comprising a plurality of switching elements;
commutation controlling means for performing commutation control with respect to the plurality of switching elements of each of the plurality of bidirectional switches using a commutation pattern comprising a plurality of steps so as to switch connection between the plurality of input phases and the plurality of output phases through the power convertor;
error compensating means for calculating a compensation amount to decrease an error in an output voltage caused by the commutation control; and
compensation amount adjusting means for decreasing the compensation amount based on at least one voltage among voltages of the plurality of output phases.
